(19) United States
(12) Patent Application Publication
(10) Pub. No.: US 2014/0201694 A1
(43) Pub. Date: Jul. 17, 2014

(54) Wrap Based Fill In Layout Designs

(71) Applicant: Mentor Graphics Corporation, Wilsonville, OR (US)

(72) Inventor: William S. Graupp, Wilsonville, OR (US)

(73) Assignee: Mentor Graphics Corporation, Wilsonville, OR (US)

(21) Appl. No.: 14/156,445

(22) Filed: Jan. 15, 2014

Related U.S. Application Data
(60) Provisional application No. 61/752,939, filed on Jan. 15, 2013.

(51) Int. Cl. G06F 17/50

(52) U.S. Cl. CPC G06F 17/5072
USPC 716/119

(57) ABSTRACT

Techniques for “wrapping” functional geometric elements with fill geometric elements are provided. With some implementations, functional geometric elements, such as geometric elements representing metal contact and interconnect structures, are identified in layout design data. Next, fill regions requiring fill geometric elements are identified. If a portion of a functional geometric element faces a fill region, then that portion of the functional geometric element is “wrapped” with fill structures. Typically, the exposed portions of the functional geometric elements are wrapped before the remaining fill region is populated with fill geometric elements. By wrapping the exposed portions of the functional geometric elements, a designer can surround the functional geometric elements with a predictable pattern of fill geometric elements that can serve to protect the functional geometric elements from, for example, the capacitive effect of other fill geometric elements in the fill region.

### RELATED APPLICATIONS

This application is a non-provisional of and claims priority under 35 U.S.C. §119 to U.S. Provisional Patent Application No. 61/752,939, entitled “Wrap Based Fill In Layout Designs,” filed on Jan. 15, 2013, and naming William S. Graupp as inventor, which application is incorporated entirely herein by reference.

### FIELD OF THE INVENTION

The present invention relates to various techniques and tools to assist in the design of a circuit device, such as an integrated circuit design. Various aspects of the present invention are particularly applicable to providing structures to fill open spaces on the surfaces of layers in a circuit device.

### BACKGROUND

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit, its complexity, the design team, and the microcircuit fabricator or foundry that will manufacture the microcircuit. Software and hardware “tools” then verify the design at various stages of the design flow by running software simulators and/or hardware emulators, and errors in the design are corrected.

Several steps are common to most design flows. First, the specifications for the new microcircuit are described in terms of logical operations, typically using a Hardware Design Language (HDL), such as the Very high speed integrated circuit Hardware Design Language (VHDL). After the accuracy of the logical design is confirmed, the logical design is converted into device design data by synthesis software. The device design data, in the form of a schematic, represents the specific electronic devices, such as transistors, resistors, and capacitors, which will achieve the desired logical result and their interconnections. Preliminary timing estimates for portions of the circuit may also be made at this stage, using an assumed characteristic speed for each device. This schematic generally corresponds to the level of representation displayed in conventional circuit diagrams.

Once the relationships between circuit devices have been established, the design is again transformed into physical design data describing specific geometric elements, often referred to as a “layout” design. These geometric elements (typically polygons) define the shapes that will be created in various materials to form the specified circuit devices. Custom layout editors, such as Mentor Graphics' IC Station or Cadence's Virtuoso, are commonly used for this task. Automated place and route tools also will frequently be used to define the physical layouts, especially the placement of wires that will be used to interconnect the circuit devices. Each layer of the microcircuit will have a corresponding layer representation in the layout design, and the geometric shapes described in a layer representation will define the relative locations of the circuit elements that will make up the circuit device. For example, the shapes in the representation of an implant layer will define the regions where doping will occur, while the shapes in the representation of a metal layer will define the locations of metal wires used to connect the circuit devices. Thus, the layout design data represents the patterns that may be written onto masks used to fabricate the desired microcircuit during a photolithographic process.

Modern integrated circuits typically will be formed of multiple layers of material, such as metal, diffusion material, and polysilicon. During the manufacturing process, layers of material are formed on top of one another sequentially. After each layer is created, portions of the layer are removed to create circuit element structures. Together, the circuit element structures form the operational circuit devices which make up the integrated circuit, such as transistors, capacitors and resistors. Before a new layer is formed over the circuit element structures in an existing layer, however, the existing layer must be polished to ensure planarity. Polishing, using any of various types of polishing processes, is sometimes generically referred to as “planarization.”

One problem with conventional planarization methods is that different materials will have different densities, so softer materials will be polished more than harder materials. As a result, a layer's surface may become uneven, causing the next layer to have an uneven surface as well. If this occurs, upper (i.e., subsequently formed) layers of material will have a very irregular surface topography. Such irregular surface topographies may cause a variety of flaws in a circuit device, such as holes, loss of contact, and other defects.

To improve the planarity of a layer of material, the integrated circuit designer (or manufacturer) often will analyze the layout circuit design for the layer to identify empty regions. For example, the designer or manufacturer may analyze the design of the layer to determine the density of the functional structures that will be formed in the layer. That is, the designer or manufacturer may determine the density of “functional” geometric elements (i.e., those geometric elements in the layout design data that represent functional structures that will be manufactured from the design data in the integrated circuit device) and identify regions that are empty of these functional geometric elements. The designer or manufacturer will then modify the layout circuit design to fill these empty regions with data representing “dummy” or “fill” geometric elements. That is, the designer or manufacturer will modify a design to increase the density of structures that will be formed in the layer. When the circuit is manufactured, these “dummy” or “fill” structures will be formed alongside the “functional” circuit element structures, so that the overall surface of the layer is more consistently flat. This type of corrective technique may be implemented using a software application for identifying and manipulating structures defined in a layout circuit design, such as one or more tools in the CALIBRE® family of software tools available from Mentor Graphics® Corporation of Wilsonville, Oreg.

While this corrective technique often improves the planarity of layers in an integrated circuit, it has some drawbacks. For example, fill structures that are not electronically coupled to an interconnect (e.g., a signal line or wire) or other functional circuit structure can be automatically generated when the circuit design is finalized. These “floating” fill structures can significantly increase the coupling capacitance between adjacent interconnects, however, which in turn may create unwanted crosstalk between adjacent interconnects. These “floating” fill structures may also increase the total interconnect capacitance for the layer.

On the other hand, if a fill structure is electrically coupled to an interconnect, then this “grounded” fill structure may significantly increase the interconnect's total capacitance. This increased interconnect total capacitance in turn may affect the delay of signals carried by the interconnect. Thus, if the designer or manufacturer inadvertently fills too much of the empty regions with grounded fill structures, the increased capacitance in the manufactured device may cause one or more of the circuit devices to exceed their minimum timing requirements. In addition, “grounded” fill structures must be routed like the interconnects, creating further complexity for the circuit design.

To address these deficiencies, various fill techniques have focused on manipulating the shape of the fill structures, or their placement relative to other functional structures in a layer of a circuit. For example, some techniques may place long fill structures parallel to interconnect lines, while other techniques may place fill structures orthogonal to interconnect lines. While a variety of fill techniques have been proposed, there is still a continuing desire to be able to add fill structures to a circuit while curtailing the amount of additional capacitance created by the additional fill structures.

### BRIEF SUMMARY

Various examples of the invention provide techniques for “wrapping” functional geometric elements with fill geometric elements. For example, with some implementations of the invention, functional geometric elements, such as geometric elements representing metal contact and interconnect structures, are identified in layout design data. Next, fill regions requiring fill geometric elements are identified. If a portion of a functional geometric element faces a fill region, then that portion of the functional geometric element is “wrapped” with fill structures. Typically, the exposed portions of the functional geometric elements are wrapped before the remaining fill region is populated with fill geometric elements. By wrapping the exposed portions of the functional geometric elements, the designer can surround the functional geometric elements with a predictable pattern of fill geometric elements. This may serve to protect the functional geometric elements from, for example, the capacitive effect of other fill geometric elements in the fill region.

### BRIEF DESCRIPTION OF THE DRAWINGS

FIG. 1 illustrates an example of a computing device that may be employed to implement various examples of the invention.

FIG. 2 illustrates a tool that can be used to add data representing fill geometric elements to circuit layout design data according to various examples of the invention.

FIG. 3 illustrates a flowchart describing a method of adding data representing fill structures to a circuit design that may be implemented according to various examples of the invention.

FIG. 4 illustrates an example of fill regions that may be identified in a layout circuit design according to various examples of the invention.

FIGS. 5-7 illustrate examples of patterns of fill geometric elements representing fill structures that may be employed according to various examples of the invention.

FIG. 8 illustrates an example of a wrap fill region that may be implemented according to various examples of the invention

FIGS. 9 and 10 illustrate an example of the partitioning of the wrap fill region 803 according to various implementations of the invention.

FIGS. 11 and 12 illustrate the placement of wrap fill geometric elements in wrap fill regions according to various implementations of the invention.

### DETAILED DESCRIPTION OF EMBODIMENTS OF THE INVENTION

### Illustrative Operating Environment

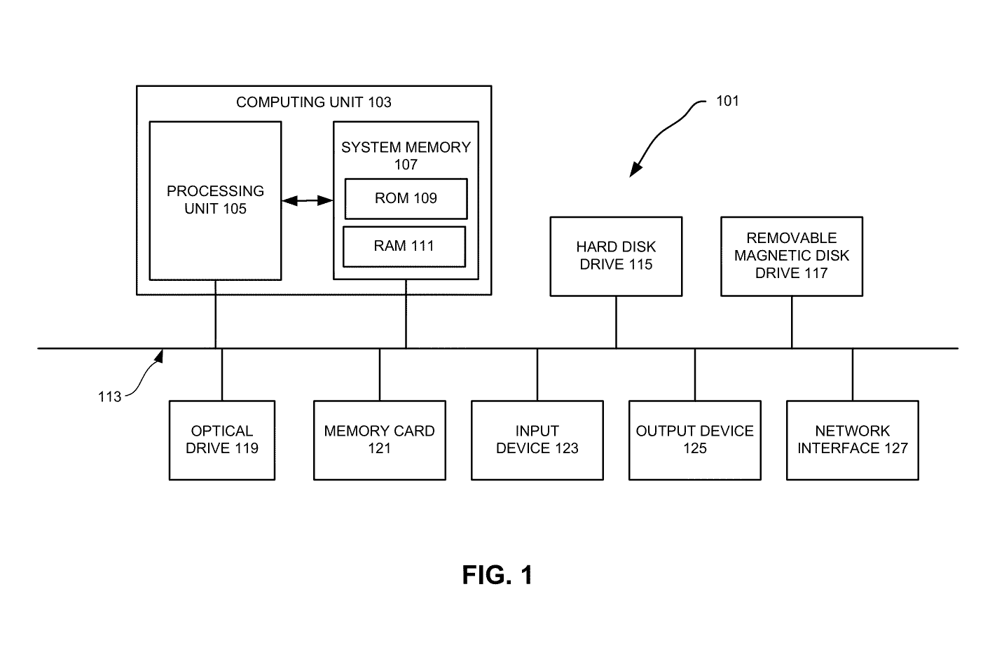

Various examples of the invention may be implemented through the execution of software instructions by a computing device, such as a programmable computer, by computer-executable instructions stored on a non-transitory storage device, or by some combination thereof. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices. For example, the processing unit 105 or the system memory 107 may be directly or indirectly connected to one or more additional memory storage devices, such as a “hard” magnetic disk drive 115, a removable magnetic disk drive 117, an optical disk drive 119, or a flash memory card 121. The processing unit 105 and the system memory 107 also may be directly or indirectly connected to one or more input devices 123 and one or more output devices 125. The input devices 123 may include, for example, a keyboard, a pointing device (such as a mouse, touchpad, stylus, trackball, or joystick), a scanner, a camera, and a microphone. The output devices 125 may include, for example, a monitor display, a printer and speakers. With various examples of the computer 101, one or more of the peripheral devices 115-125 may be internally housed with the computing unit 103. Alternately, one or more of the peripheral devices 115-125 may be external to the housing for the computing unit 103 and connected to the bus 113 through, for example, a Universal Serial Bus (USB) connection.

As will also be appreciated by those of ordinary skill in the art, executable instructions for implanting various embodiments of the invention may be stored on a non-transitory memory storage device, such as the read-only memory (ROM) 109, the random access memory (RAM) 111, the fixed magnetic disk drive 115, the removable magnetic disk drive 117, the optical disk drive 119, the a flash memory card 121, or some combination thereof. As used herein, the term non-transitory refers to storage of information over a period of time such that the information may be retrieved for use at any arbitrary point during that period of time.

With some implementations, the computing unit 103 may be directly or indirectly connected to one or more network interfaces 127 for communicating with other devices making up a network. The network interface 127 translates data and control signals from the computing unit 103 into network messages according to one or more communication protocols, such as the transmission control protocol (TCP) and the Internet protocol (IP). Also, the interface 127 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computer 101 is illustrated as an example only, and it not intended to be limiting. Various embodiments of the invention may be implemented using one or more computing devices that include the components of the computer 101 illustrated in FIG. 1, which include only a subset of the components illustrated in FIG. 1, or which include an alternate combination of components, including components that are not shown in FIG. 1. For example, various embodiments of the invention may be implemented using a multi-processor computer, a plurality of single and/or multiprocessor computers arranged into a network, or some combination of both.

### Wrap Fill Element Placement Tool

As noted above, various embodiments of the invention may be implemented by the execution of software instructions with a programmable computer. For example, some embodiments of the invention may be implemented using the CALIBRE® software tools available from Mentor Graphics® Corporation of Wilsonville, Oreg. It should be appreciated, however, that other software tools for identifying and manipulating data in a layout circuit design are known in the art, and thus may alternately or additionally be used to implement various examples of the invention. Further, a user may employ separate software tools in combination to implement various aspects of the invention. For example, a user may employ one or more software tools, such as the CALIBRE® software tools, to identify fill regions in a layout circuit design, and then use one or more other software tools, such as proprietary software tools, or other tools available from Mentor Graphics® Corporation or other tool vendors, to add fill structures to those fill regions.

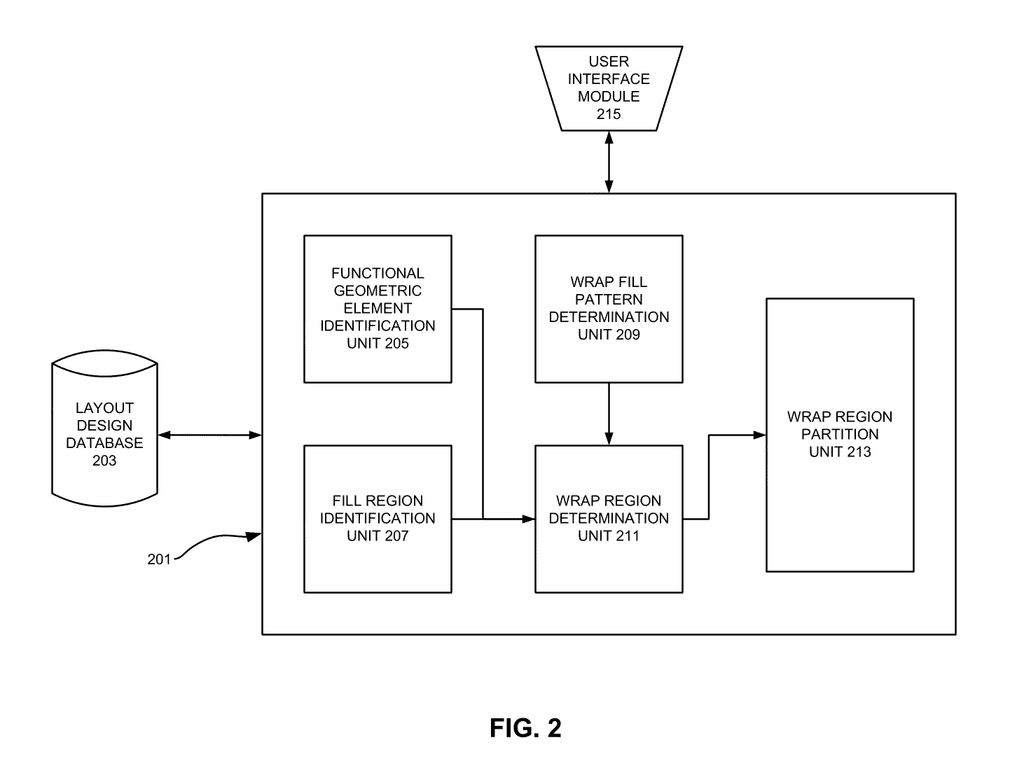

FIG. 2 illustrates an example of a wrap fill element placement tool 201 that may be employed according to various examples of the invention to add data representing fill structures to circuit layout design data. As will be discussed in more detail below, the wrap fill element placement tool 201 can be used to modify a circuit design so that one or more layers in the design will have fill structures, thereby increasing its structure density. With some examples of the invention, initial circuit design data may be provided directly to the wrap fill element placement tool 201. Alternately, the wrap fill element placement tool 201 may retrieve circuit design data from a database, such as the design database 203.

With various examples of the invention, the circuit design data may be in any desired type of data format. Integrated circuit layout design descriptions can be provided in many different formats, such as the Graphic Data System II (GDSII) format. This data format is popular for transferring and archiving 2D graphical IC layout data. Among other features, it contains a hierarchy of structures, each structure containing layout elements (e.g., polygons, paths or poly-lines, circles and textboxes). The elements are situated on layers. Other formats that may alternately or additionally be employed according to various examples of the invention include an open source format named Open Access, Milkyway by Synopsys, Inc., EDDM by Mentor Graphics, Inc., and the more recent, Open Artwork System Interchange Standard (OASIS) proposed by Semiconductor Equipment and Materials International (SEMI). These various industry formats can be used for describing the geometrical information related to describing an IC layout that can be used by fabrication facilities to manufacture the IC according to design.

Also, as used herein, the term “design” is intended to encompass data describing an entire microdevice, such as an integrated circuit device or micro-electromechanical system (MEMS) device. This term also is intended to encompass a smaller group of data describing one or more components of an entire microdevice, however, such as a layer of an integrated circuit device, or even a portion of a layer of an integrated circuit device. Still further, the term “design” also is intended to encompass data describing more than one microdevice, such as data to be used to create a mask or reticle for simultaneously forming multiple microdevices on a single wafer.

As seen in FIG. 2, the wrap fill element placement tool 201 includes a functional geometric element identification unit 205, a fill region identification unit 207, and a wrap fill pattern determination unit 209. The wrap fill element placement tool 201 also includes a wrap region determination unit 211 and a wrap region partition unit 213. Further, the wrap fill element placement tool 201 may optionally include a user interface module 215.

As previously noted, various examples of the invention may be implemented by a computing system, such as the computing system 101 illustrated in FIG. 1. Accordingly, one or more components of each of the functional geometric element identification unit 205, the fill region identification unit 207, the wrap fill pattern determination unit 209, the wrap region determination unit 211, the wrap region partition unit 213, and the user interface module 215 may be implemented using one or more processors in a multiprocessor computing system's master computer, one or more servant computers in a multiprocessor computing system, or some combination of both. It also should be appreciated that, while the functional geometric element identification unit 205, the fill region identification unit 207, the wrap fill pattern determination unit 209, the wrap region determination unit 211, the wrap region partition unit 213, and the user interface module 215 are shown as separate units in FIG. 2, a single computer (or a single processor or processor core within a computer) may be used to implement two or more of these modules at different times. Of course, still other embodiments of the invention may be implemented by, for example, one or more computer-readable devices having such software instructions stored thereon in a non-transitory manner, i.e., stored over a period of time such that they may be retrieved for use at any arbitrary point during that period of time.

As previously noted, the wrap fill element placement tool 201 may work with a layout design database 203. The layout design database 203 may be implemented using any data storage device that is capable of storing layout design data and accessible to the wrap fill element placement tool 201. For example, the layout design database 203 may be implemented using a magnetic disk drive, a rewritable optical disk drive, a “punch” type memory device, a holographic memory device, etc. Of course, while a single layout design database 203 device is illustrated in FIG. 2, alternate examples of the invention may employ two or more separate memory storage devices working in concert to form the layout design database 203. With various examples of the invention, the layout design database 203 may store layout design data as part of a database for storing design data for use in one or more other electronic design automation processes. For example, the layout design database 203 may store the layout design data as part of a hierarchical database used in conjunction with one or more physical verification or resolution enhancement technique tools, such as the family of Calibre® software design tools available from Mentor Graphics® Corporation of Wilsonville, Oreg. It should be noted that, with various examples of the invention, the wrap fill element placement tool 201 may be implemented as part of another electronic design automation tool, such as a layout design rule check tool, a layout design-for-manufacturability tool, etc.

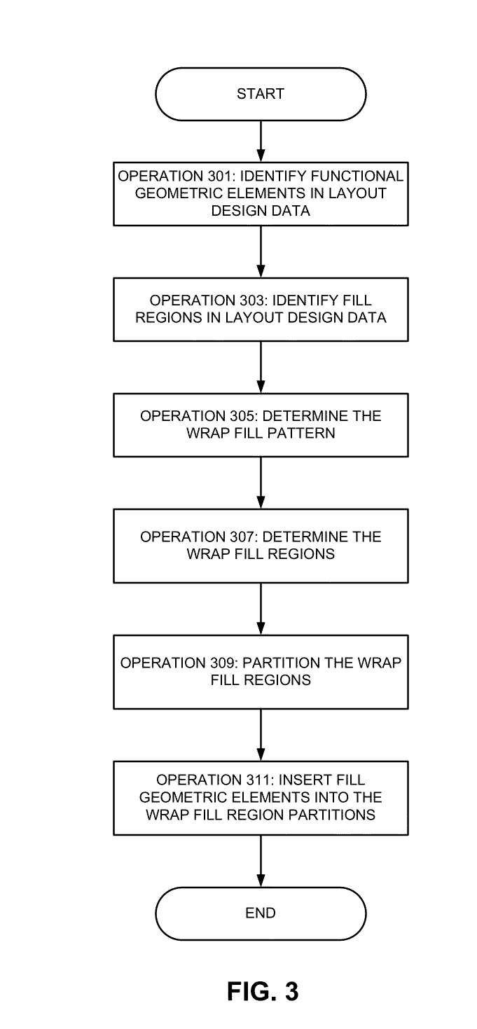

The operation of the wrap fill element placement tool 201 will be described in more detail with reference to the flowchart illustrated in FIG. 3.

### Identifying Fill Regions

Initially, in operation 301, a user (such as, for example, a circuit designer, a manufacturer, or other authorized person) initiates the functional geometric element identification unit 205 to identify functional geometric elements in layout design data, and in operation 303 activates the fill region identification unit 207 to identify fill regions in the circuit layout design data. The user may, for example, initiate the operations of the functional geometric element identification unit 205 and the fill region identification unit 207 through the user interface module 215. Alternately, the functional geometric element identification unit 205 and the fill region identification unit 207 may be activated automatically as part of a larger electronic design automation (EDA) process. In response, the functional geometric element identification unit 205 will identify functional geometric elements in the design data, and the fill region identification unit 207 will identify areas in a circuit design that are empty of existing structures, respectively.

Typically, the wrap fill element placement tool 201 will operate on a “layout” type circuit design. In a “layout” type circuit design, a physical structure conventionally is represented by a geometric element, such as a polygon. During a photolithographic manufacturing process, the geometric element representing the structure will be recreated on a photolithographic mask, which then will be used to form the structure in a physical layer of the circuit. Geometric elements in a layout type circuit design can generally be organized into two separate categories: functional geometric elements and fill geometric elements. Functional geometric elements represent the structures in a circuit that will perform some type of electrical function, such as wiring or interconnect lines, transistor gates, resistors, etc. Fill geometric elements, on the other hand, represent structures that will not perform any type of electrical function. Fill geometric elements may instead represent structures that serve primarily to, e.g., maintain a desired planarity for a layer in the resulting circuit.

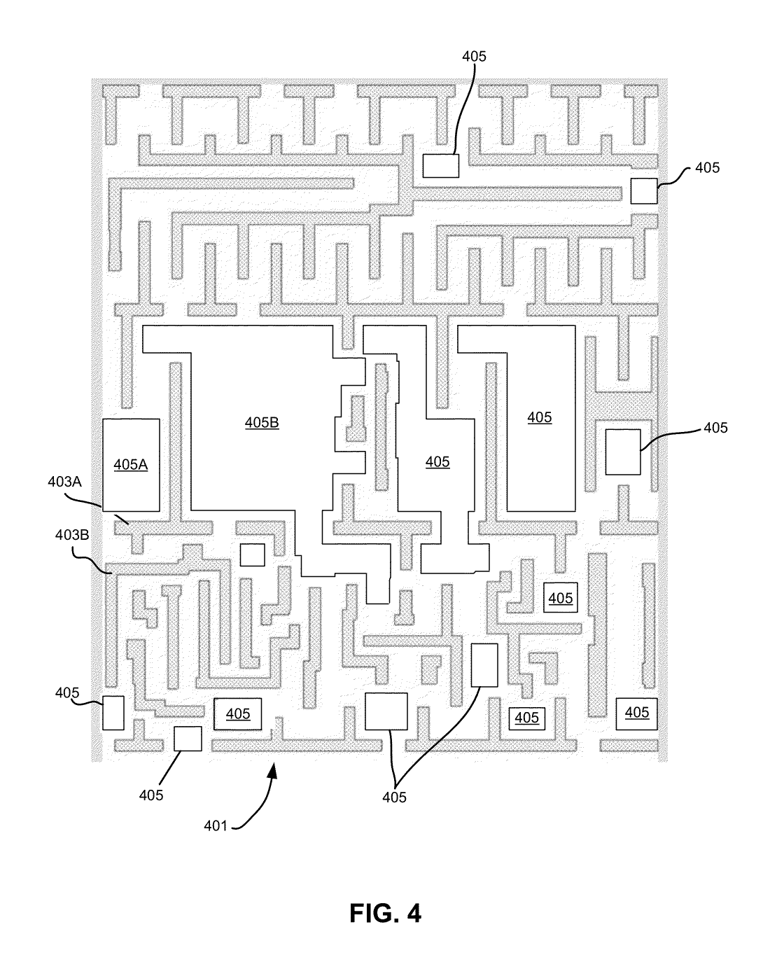

FIG. 4 illustrates an example of a layout circuit design 401 that includes several different functional polygons 403. As seen in this figure, there are empty areas between the functional polygons 403. As known in the art, the fill region identification unit 207 analyzes these empty areas, to identify portions of these areas that will be suitable fill regions. For example, a user may specify that the perimeter of a fill region must be a threshold distance away from any adjacent functional polygons. Based upon the specified parameters for generating fill regions, the fill region identification unit 207 will identify and designate portions of the empty areas as fill regions. For example, area portions 405 shown in FIG. 4 may be designated as fill regions. Various implementations of the invention may allow a user to specify any desired criteria for defining fill regions, such as a minimum area requirement, minimum dimensions requirements in one or two directions, a specified threshold distance away from other fill regions, etc.

Also, it should be appreciated that, while the functional geometric element identification unit 205 and the fill region identification unit 207 are described herein as separate units operating independently, those of ordinary skill in the art will appreciate that the functional geometric element identification unit 205 and the fill region identification unit 207 may be combined into a single unit, and may perform the operations of identifying the functional geometric elements and the fill regions concurrently. Still further, the operation of the functional geometric element identification unit 205 and the fill region identification unit 207 may be related. For example, with some implementations of the invention, the functional geometric element identification unit 205 may not identify every functional geometric element within a design or designated region. Rather, as the fill region identification unit 207 identifies fill regions, the functional geometric element identification unit 205 may identify only those functional geometric elements that are exposed to an identified fill region. This may be accomplished by, for example, identifying functional geometric elements that first intersect lines extending orthogonally from the perimeter of the fill region or, identifying those functional geometric elements that were used to initially identify the fill region.

### Determining the Wrap Fill Pattern

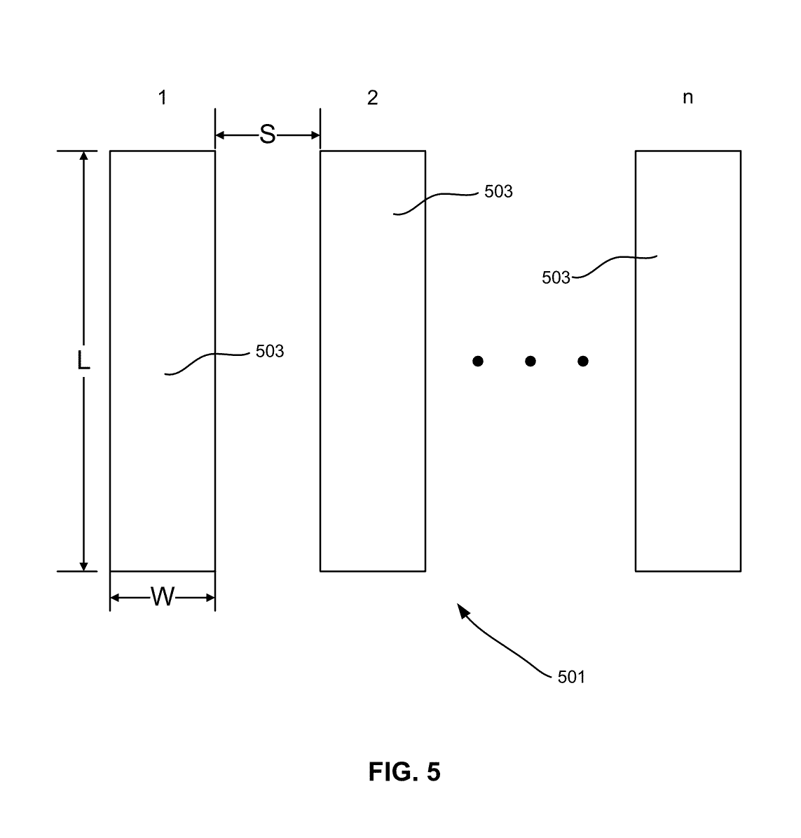

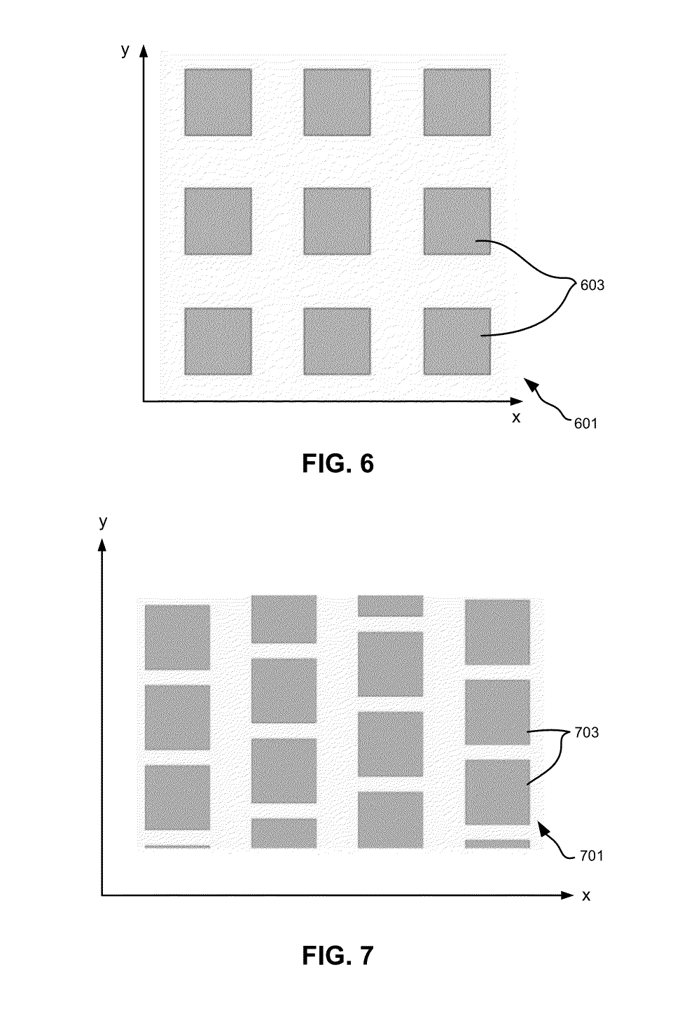

In operation 305, the wrap fill pattern determination unit 209 determines the wrap fill pattern that will be used to wrap functional geometric elements in the layout design data. FIG. 5 illustrates one example of a pattern 501 of fill geometric elements 503. Typically, each fill geometric element 503 has a rectangular shape or “footprint,” defined by a length L and a width W. Also, as shown in the illustrated example, the pattern 501 includes a number n of fill geometric elements 503 extending in at least one direction. Typically, the fill geometric elements 503 will have a regular spacing S in between each of them. It should be appreciated, however, that various implementations of wrap fill element placement tool 201 may add fill geometric elements 503 in any desired arrangement. For example, the fill geometric elements may extend in both a “vertical” and a “horizontal” direction, as illustrated by the pattern 601 of fill geometric elements 603 shown in FIG. 6, or they may have a different spacing in the x-axis direction than in the y-axis direction, as illustrated by the pattern 701 of fill geometric elements 703 in FIG. 7. Still further, the fill geometric elements may include rectangular polygons, hexagonal polygons, octagonal polygons, or polygons of any desired shape, including irregularly shaped polygons. Also, the size of the pattern may vary.

With various examples of the invention, the characteristics of the pattern of fill geometric elements may be determined by, for example, a designer working through the user interface module 215. Alternately or additionally, the characteristics of the pattern of fill geometric elements (or some portion of them) may be predetermined or determined automatically by the wrap fill element placement tool 201 or other electronic design automation tool according to any desired criteria.

### Wrap Region Determination

In operation 307, the wrap fill pattern determination unit 209 determines the regions for inserting the wrap fill geometric elements around the functional geometric elements. As previously noted, the wrap fill geometric elements are provided adjacent to those portions of the functional geometric elements exposed to a fill region. For example, FIG. 4 illustrates two functional geometric elements 403A and 403B. Because functional geometric element 403A is located relatively close to functional geometric element 403B, there are no fill regions between the functional geometric elements. As seen in this figure, however, the upper portion of functional geometric element 403A is exposed to both fill region 405A and fill region 405B. Accordingly, various implementations of the invention will place the wrap fill pattern along the portion of the functional geometric element 403A that faces the fill region 405A, and along the portion that faces the fill region 405B.

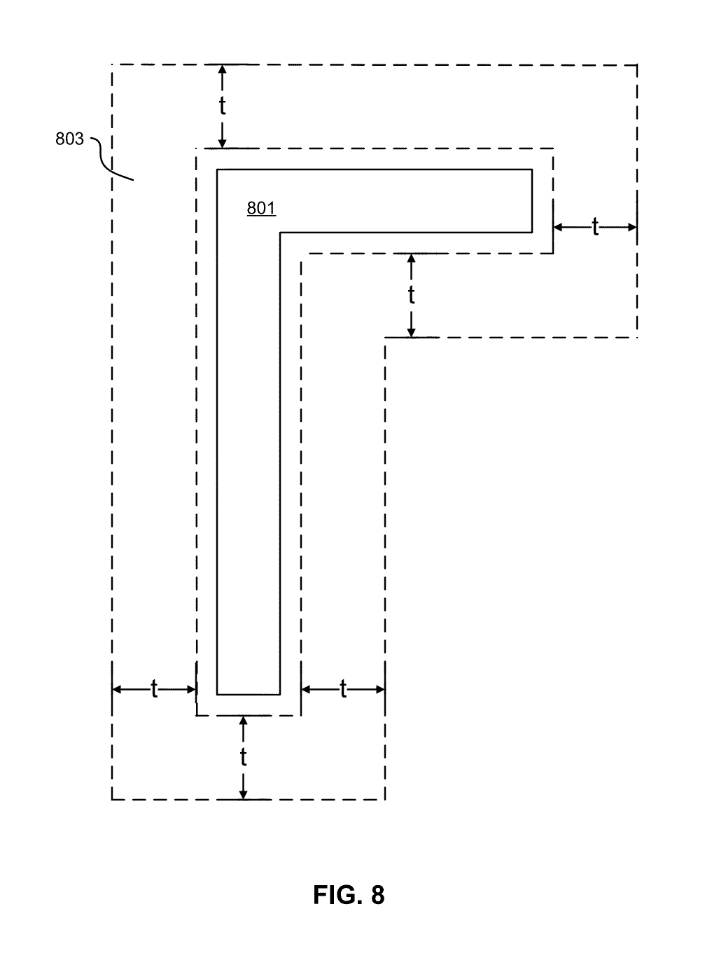

More particularly, the wrap region determination unit 211 will create wrap fill regions along the portions of a functional geometric element that faces a fill region. For ease of understanding, FIG. 8 illustrates a functional geometric element 801 that is surrounded on all sides by fill regions. Accordingly, the wrap region determination unit 211 will create a wrap fill region 803 that completely encircles the functional geometric element 801.

With various examples of the invention, the wrap fill region created by the wrap region determination unit 211 will be based upon the pattern of fill geometric elements. For example, if the wrap fill element placement tool 201 is using the pattern 501 of fill geometric elements 503 shown in FIG. 5, the wrap fill region 803 will have a width t, where

t=(n·W)+((n−1)·S)

where W is the width of a fill geometric element and the pattern includes a number n of fill geometric elements extending in a direction with a regular spacing S in between each of them.

### Partitioning of the Wrap Fill Regions

With various implementations of the invention, once the wrap fill regions have been determined, then the wrap fill geometric elements can be placed in the wrap fill regions. For example, with some implementations of the invention, the wrap fill geometric elements can be placed in the wrap fill regions manually.

Typically, however, a designer will want to use a fill placement tool, such as the SmartFill fill placement tool (available as part of the Calibre® family of electronic design automation tools available from Mentor Graphics® Corporation of Wilsonville, Oreg.) to automatically place the wrap fill geometric elements in the wrap fill region. Also, if the wrap fill element placement tool 201 is being employed by another electronic design automation tool, that tool will need to use an automatic fill placement tool to place the wrap fill geometric elements in the wrap fill regions.

In some instances, however, it may be undesirable to use an automatic fill placement tool to place the wrap fill geometric elements in wrap fill regions that are not rectangular. For example, in an attempt to maximize the amount of wrap fill placed at the bottom left portion of the functional geometric element 801, a fill placement tool may place the wrap fill geometric elements such that the wrap fill pattern leaves insufficient wrap fill geometric elements at the top right portion of the functional geometric element 801.

Accordingly, various implementations of the invention may optionally provide the wrap region partition unit 213. With these implementations, in operation 309, the wrap fill regions are partitioned into smaller wrap fill regions. More particularly, one or more of the wrap fill regions may be partitioned into smaller wrap fill regions (referred to herein as partitioned wrap fill regions) of specific discrete shapes, such as discrete rectangles or squares. Various embodiments of the invention may employ any desired technique for partitioning the wrap fill regions into partitioned wrap fill regions. Some implementations of the invention, for example, may first create “cuts” along all “line end/space end” of a wrap fill region's zones along the long direction. Once these cuts are made, the wrap region partition unit 213 will then create cuts in all remaining edges of the wrap fill region in the unified direction of the material layer (e.g., in a vertical direction for a metal conduction layer with predominantly vertical interconnect lines, and in the horizontal direction for a metal conduction layer with predominantly horizontal interconnect lines). The wrap region partition unit 213 will then remerge regions with exact matching parallel run lengths to optimize the various partitioned wrap fill regions.

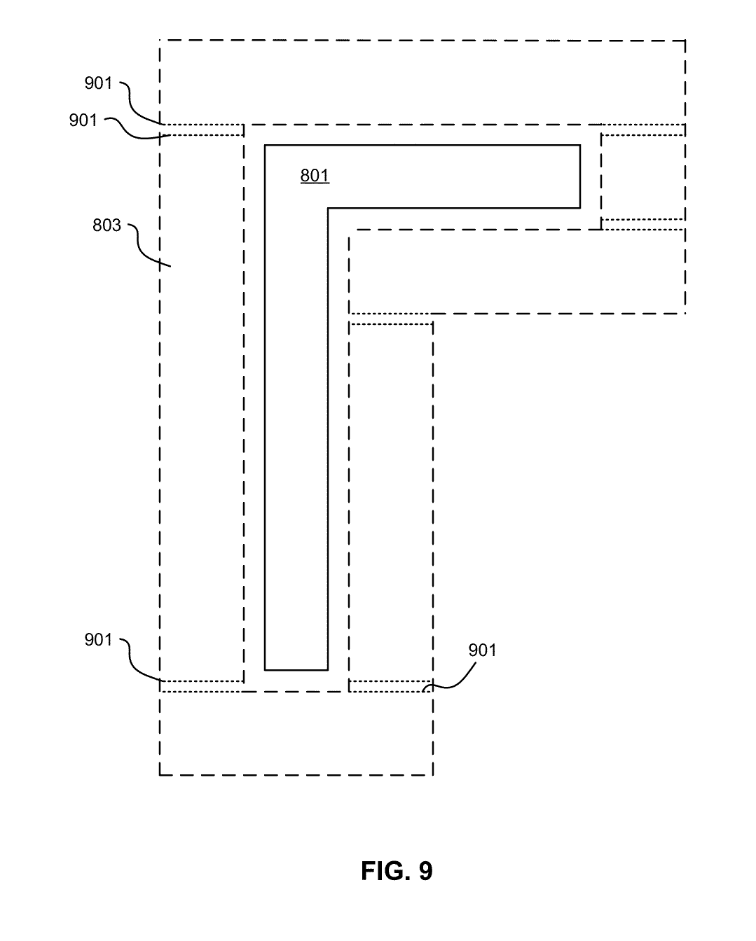

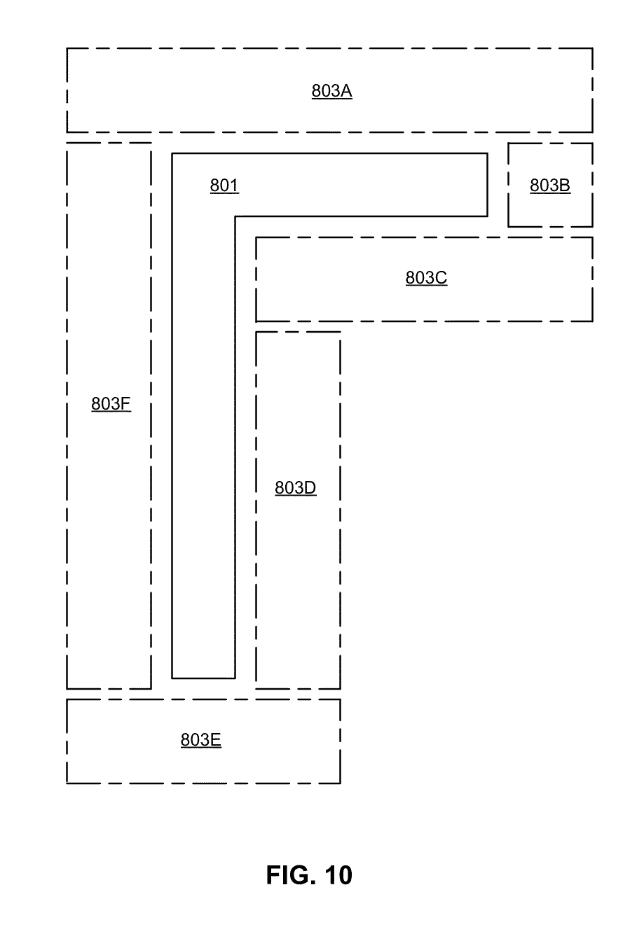

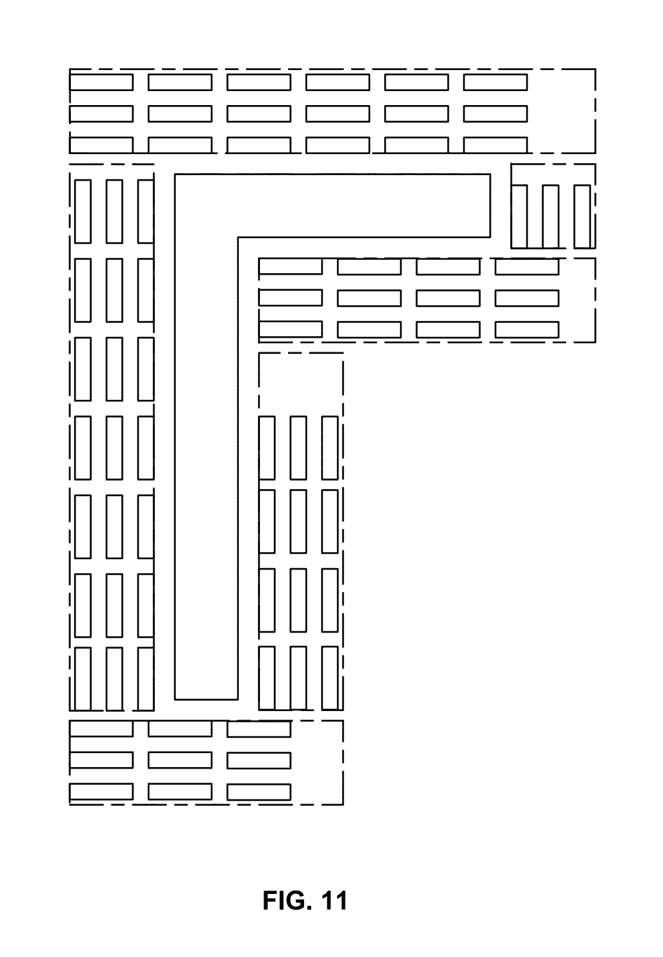

FIGS. 9 and 10 illustrate an example of the partitioning of the wrap fill region 803 that may be made according to various implementations of the invention. As seen in this figure, cuts 901 are made at various locations in the wrap fill region 803. These cuts divide the original wrap fill region up into various partitioned wrap fill region 803A-803F, as shown in FIG. 10. It should be appreciated, however, that this example of partitioning is made for convenience of understanding only and is purely illustrative, and is not intended to be limiting or descriptive of any particular portioning technique or criteria. Also, while a distance is shown between the cuts 901 and the resulting partitions 803A-803F, these distances are illustrated for ease of convenience only, and adjacent partitioned wrap fill regions may have no distance therebetween.

### Wrap Fill Placement

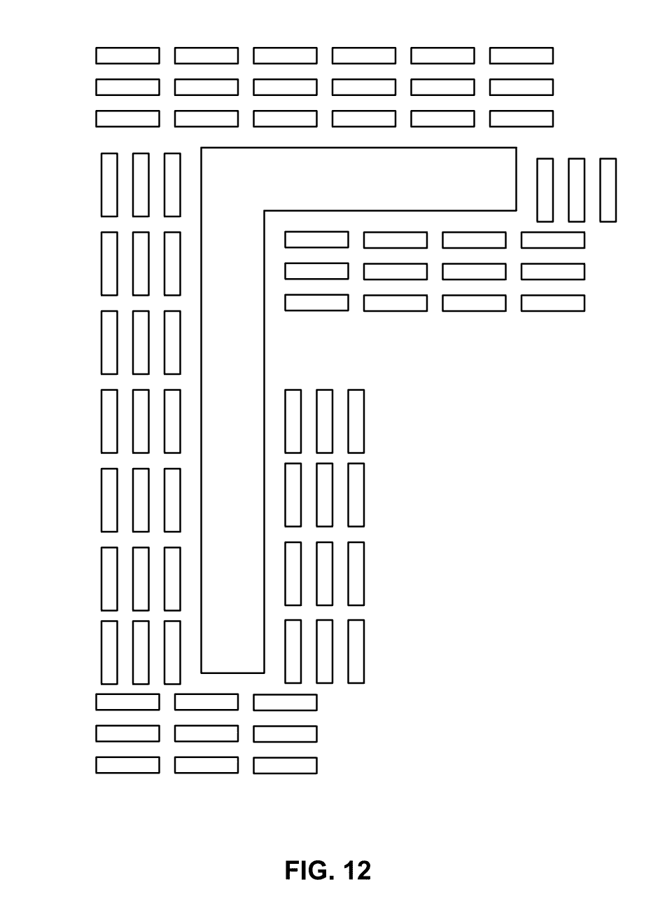

Once the wrap fill regions (including, where applicable, partitioned wrap fill regions) have been created, a conventional fill placement tool can more efficiently be used to place the desired pattern of wrap fill geometric elements in the regions. For example as illustrated in FIG. 12, the partitioned wrap fill regions 803A-803F have been filled using the fill pattern 501 shown in FIG. 5. In this manner, various implementations of the invention can be used to produce a wrapping of fill geometric elements around functional geometric elements as shown in this figure.

With various examples of the invention, a conventional fill placement tool may attempt to place the wrap fill geometric elements, so as to maximize the number of wrap fill geometric elements within the wrap fill regions and, where applicable, partitioned wrap fill regions. That is, for each wrap fill region and partitioned wrap fill region, a conventional fill placement tool may determine a placement for the pattern of wrap fill geometric elements that seems to best maximize the area of the wrap fill geometric elements that will fit into a particular wrap fill region or partitioned wrap fill region. It should be appreciated that, with some implementations of the inventions, the pattern may not be limited to entire wrap fill geometric elements, but also may include only portions of wrap fill geometric elements where space does not permit the placement of entire wrap fill geometric elements. In addition to placement techniques that maximize the area of the wrap fill geometric elements fitting into a wrap fill region or partitioned wrap fill region, some embodiments of the invention may alternately or additionally employ other fill techniques. For example, some fill placement tools may allow a user to designate an amount (e.g., 45%) of the wrap fill regions (including, where applicable, partitioned wrap fill regions) that should be filled with wrap fill geometric elements, and place the pattern of wrap fill geometric elements within the wrap fill regions accordingly. A variety of still other wrap fill geometric element placement criteria will be apparent to those of ordinary skill in the art, and thus will not be discussed in more detail here.

A conventional fill placement tool employed by various embodiments of the invention may use a simple effort-based technique to determine the placement of a wrap fill geometric element pattern in a wrap fill region (or a partitioned wrap fill region). With this technique, a user specifies an “effort” parameter to describe the amount of effort that the user wishes to be expended in placing the fill polygon pattern. Of course, there are a variety of alternate placement algorithms that are well known in the art, many of which are more sophisticated than the effort technique. It should be appreciated that alternate embodiments of the invention may employ any desired placement algorithm to place the wrap fill polygon pattern within the wrap fill regions, such as linear optimization algorithms, simulated annealing algorithms, Monte Carlo algorithms and the like.

Once the wrap fill regions (and, where applicable, partitioned wrap fill regions) in a fill region have been filled with fill geometric elements, the remaining portions of the fill regions can subsequently be filled with fill geometric elements. With various implementations of the invention, the remaining portions of the fill regions can subsequently be filled with fill geometric elements using any desired fill technique. Because the wrap fill regions encompass exposed regions of functional geometric elements, however, the fill geometric elements placed in the wrap fill regions (including, where applicable, partitioned wrap fill regions) likewise encompass the exposed regions of the function elements. Further, by selecting a desired fill pattern for the wrap fill regions in layout design data, a designer can ensure that, in a microdevice subsequently manufactured from the layout design data, the portions of the functional structures corresponding to the exposed portions of functional geometric elements are encompassed by fill structures corresponding to the fill geometric elements arranged in the desired pattern.

### CONCLUSION

While the invention has been described with respect to specific examples including presently preferred modes of carrying out the invention, those skilled in the art will appreciate that there are numerous variations and permutations of the above described systems and techniques that fall within the spirit and scope of the invention as set forth herein.

What is claimed is:

1. One or more computer readable non-transitory storage devices storing computer-executable instructions thereon for causing a computer to perform any of the new and nonobvious methods and method acts described herein, both alone and in combinations and subcombinations with one another.

2. A method of placing fill geometric elements in layout design data comprising any of the new and nonobvious methods and method acts described herein, both alone and in combinations and subcombinations with one another.

3. One or more computer readable non-transitory storage devices storing computer-executable instructions thereon for placing fill geometric elements in layout design data in accordance with any of the new and nonobvious methods and method acts described herein both alone and in combinations and subcombinations with one another.
